(19) United States
(12) Patent Application Publication
(10) Pub. No.: US 2014/0217860 A1
(43) Pub. Date: Aug. 7, 2014

(54) BRACKET SUPPORTING APPARATUS OF VENDING MACHINE

(71) Applicants: HON HAI PRECISION INDUSTRY CO., LTD., New Taipei (TW); HONG FU JIN PRECISION INDUSTRY ( WuHan) CO., LTD., Wuhan (CN)

(72) Inventors: YUN-LUNG CHEN, New Taipei (TW); ZHI-WU XIA, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/063,102

(22) Filed: Oct. 25, 2013

(30) Foreign Application Priority Data
Feb. 4, 2013 (CN) 2013100419171

(51) Int. Cl. G07F 9/10

(52) U.S. Cl. CPC G07F 9/10
USPC 312/35

(57) ABSTRACT

A bracket supporting apparatus includes a cabinet body, a number of first supporting brackets, a number of second supporting brackets, a product channel, a first mounting bracket, a second mounting bracket, and a product output unit. The cabinet body includes a first side plate, a second side plate, a top plate, a bottom plate, and a back plate. The number of first supporting brackets and the second mounting bracket are fixed to the first and the second side plates. The number of second supporting brackets and the product channel are mounted on the top plate. The first mounting bracket is mounted on the back plate. The product output unit is fixed to the first and the second mounting brackets. The product output unit receives a sale item dropped from the product channel and facilitates the sale item to slide towards a product output opening above the bottom plate.

### BACKGROUND

1. Technical Field

The present disclosure relates to a bracket supporting apparatus in vending machines.

2. Description of Related Art

Vending machines have product channels for accommodating products for sale. A number of supporting brackets and output channels are mounted to the vending machine to support the product channels. However, the product channels are fixed to the output channels by rivets or screws. Fixing the product channels to the vending machines may be laborious and time consuming.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a bracket supporting apparatus including a product output unit, a first mounting bracket, and a second mounting bracket.

FIG. 2 is an isometric, exploded view of the bracket supporting apparatus of FIG. 1.

FIG. 3 is an isometric, exploded view of the product output unit, the first mounting bracket and the second mounting bracket of FIG. 1.

FIG. 4 is an enlarged view of a circled portion IV of FIG. 3.

FIG. 5 is an assembled view of the bracket supporting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

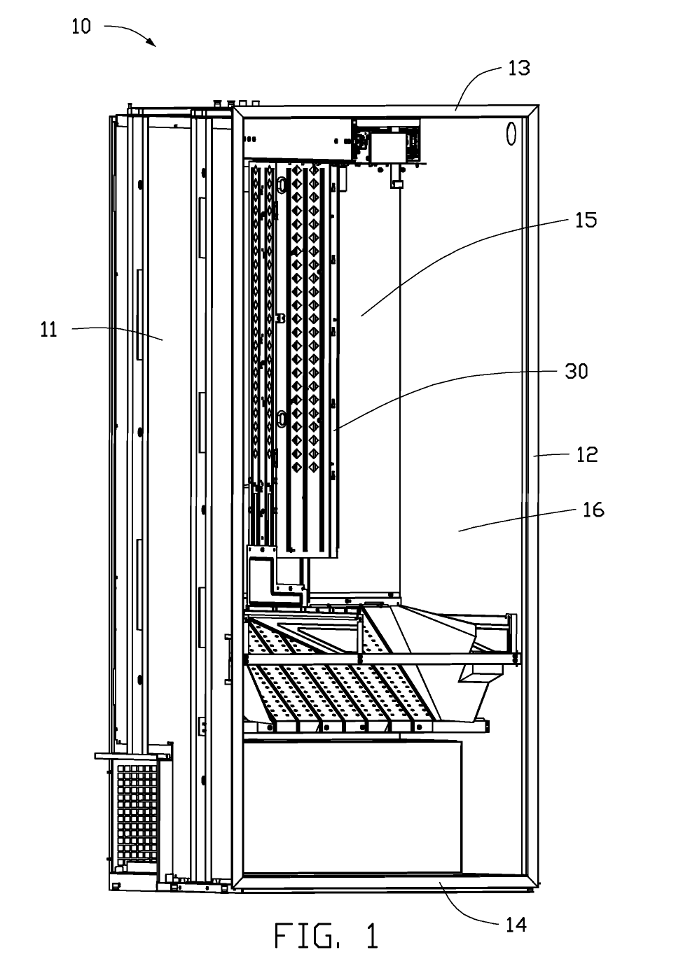

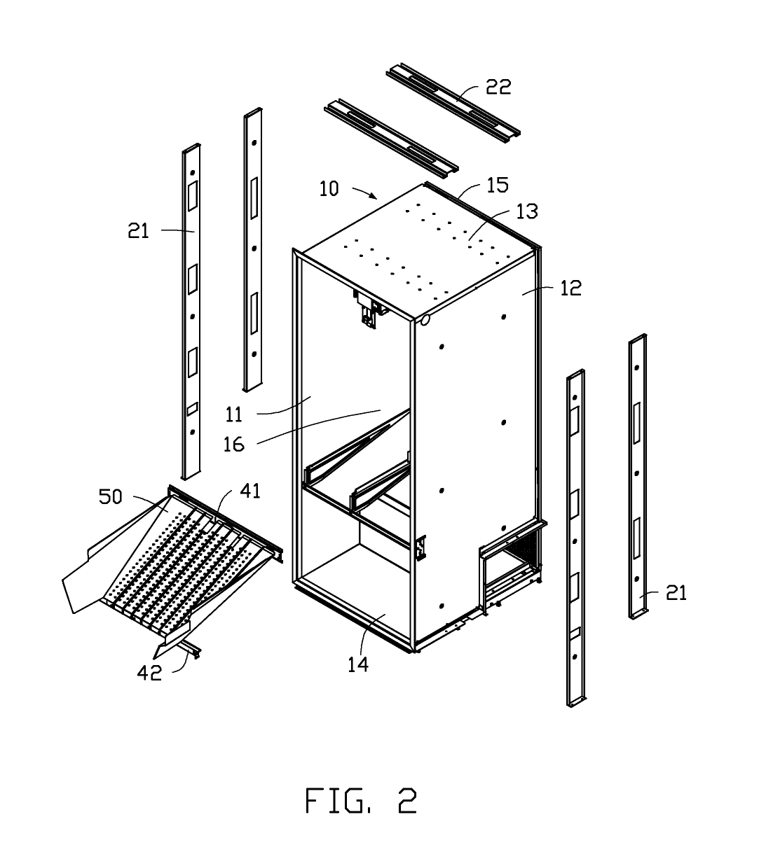

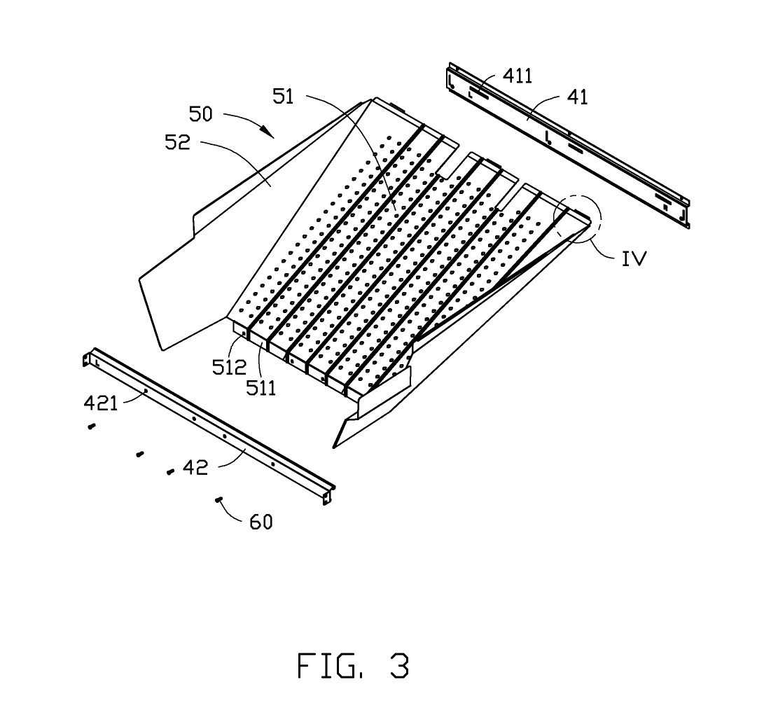

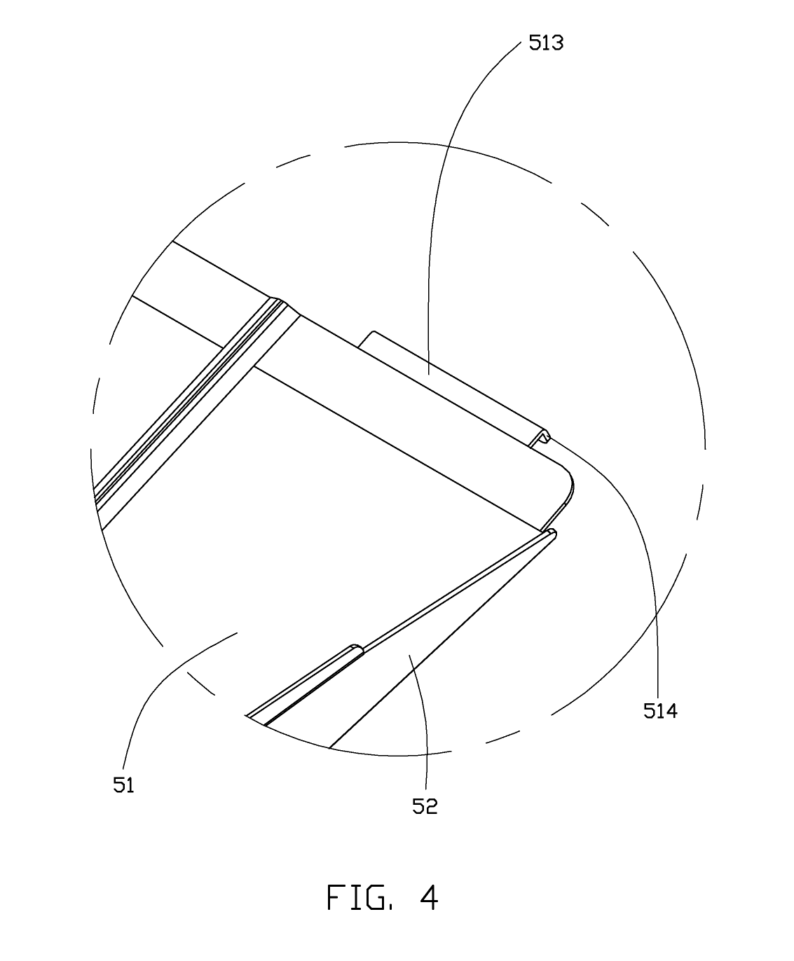

FIGS. 1 to 4 show a bracket supporting apparatus of the embodiment. The bracket supporting apparatus includes a cabinet body 10, a plurality of first supporting brackets 21, and a plurality of second supporting brackets 22. The first supporting brackets 21 and the second supporting brackets 22 are mounted on the cabinet body 10.

The cabinet body 10 includes a first side plate 11, a second side plate 12, a top plate 13, a bottom plate 14, and a back plate 15. The first side plate 11, the second side plate 12, the top plate 13, the bottom plate 14, and the back plate 15 cooperatively define an accommodating space 16. The first side plate 11 is substantially parallel to the second side plate 12. The top plate 13 is substantially parallel to the bottom plate 14. Each of the top plate 13, the bottom plate 14, and the back plate 15 is connected to each of the first side plate 11 and the second side plate 12.

In one embodiment, the plurality of first supporting brackets 21 are mounted on the first side plate 11 and on the second side plate 12 and extends substantially parallel to each other along a lengthwise direction of the first side plate 11 and the second side plate 12. The plurality of second supporting brackets 22 are mounted substantially parallel to each other on the top plate 13. In one embodiment, each of the plurality of first supporting brackets 21 is riveted to the first side plate 11 and to the second side plate 12, each of the plurality of second supporting brackets 22 is riveted to the top plate 13, and a distal end of each of the plurality of first supporting brackets 21 is riveted to a distal end of each of the plurality of second supporting brackets 22.

A product channel 30 is mounted substantially perpendicularly to the top plate 13 and is substantially perpendicular to the plurality of second supporting brackets 22. A top of the product channel 30 is mounted to the top plate 13. A bottom of the product channel 30 is mounted to a connecting plate (not labeled) on the cabinet body 10. A first mounting bracket 41 is mounted to the back plate 15. A plurality of limiting slots 411 are defined in the first mounting bracket 41. A second mounting bracket 42 is fixed to the first side plate 11 and the second side plate 12. A plurality of fixing holes 421 are defined in the second mounting bracket 42.

A product output unit 50 is received in the accommodating space 16 below the product channel 30. The product output unit 50 includes a supporting plate 51 slanted toward the bottom plate 14. Two shielding plates 52 extend from two side edges of the supporting plate 51. A fixing bracket 511 extends down from a front edge of the supporting plate 51. A plurality of through holes 512 are defined in the fixing bracket 511. A plurality of connecting brackets 513 extend from a back of the supporting plate 51. A limiting bracket 514 extends substantially perpendicularly from a back of each of the plurality of connecting brackets 513. In one embodiment, a diameter of each of the plurality of through holes 512 is substantially equal to a diameter of each of the plurality of fixing holes 421. A length of each of the plurality of limiting brackets 514 is substantially equal to a length of each of the plurality of limiting slots 411.

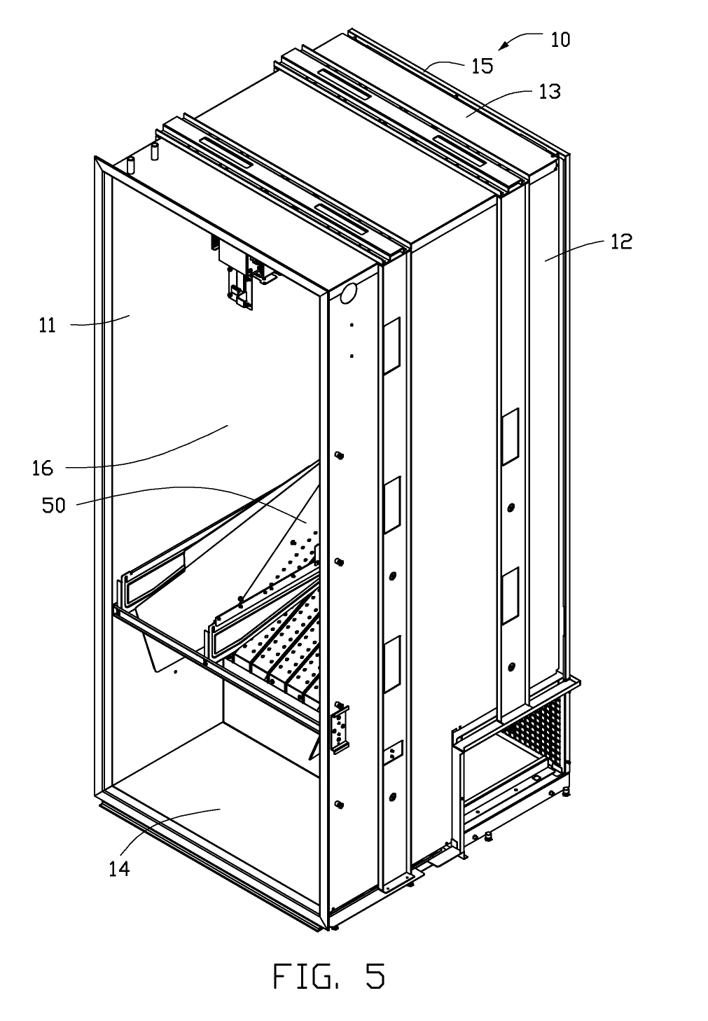

FIGS. 1 to 5 show that in assembly, each of the plurality of first supporting brackets 21 is riveted to the first side plate 11 and the second side plate 12. Each of the plurality of second supporting brackets 22 is riveted to the top plate 13. The distal end of each of the first supporting brackets 21 is riveted to the distal end of each of the second supporting brackets 22. The product channel 30 is screwed to the plurality of second supporting brackets 22 on the top plate 13 and to the connecting plate on the cabinet body 10. The first mounting bracket 41 is screwed to the back plate 15. The second mounting bracket 42 is screwed to the first side plate 11 and to the second side plate 12. Each of the limiting brackets 514 of the product output unit 50 is received through each of the limiting slots 411 of the first mounting bracket 41. Each of the plurality of fixing holes 421 of the second mounting bracket 42 aligns with each of the plurality of through holes 512 of the fixing bracket 511, and a fastener 60 is received through each of the plurality of through holes 512 and each of the plurality of fixing holes 421. Thus, the product output unit 50 is fixed to the cabinet body 10.

In operation, a plurality of sales items (not shown) are located in the product channel 30. When a sale item is bought, the sale item drops from the product channel 30 onto the supporting plate 51 of the product output unit 50 and slides to a product output opening (not shown) above the bottom plate 14. Each of the plurality of first supporting brackets 21 and each of the plurality of second supporting brackets 22 are riveted to the cabinet body 10, and the first mounting bracket 41 and the second mounting bracket 42 are screwed to the cabinet body 10. Thus, a strength of the cabinet body 10 is improved.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A bracket supporting apparatus, comprising:
a cabinet body comprising a first side plate, a second side plate, a top plate, a bottom plate and a back plate;
a plurality of first supporting brackets mounted on the first side plate and on the second side plate and arranged longitudinally;
a plurality of second supporting brackets mounted on the top plate and arranged parallel to each other;
a product channel mounted on the top plate;
a first mounting bracket mounted on the back plate;
a second mounting bracket fixed to the first side plate and to the second side plate; and
a product output unit located in the cabinet body below the product channel; wherein the product output unit is fixed to the first mounting bracket and to the second mounting bracket; and the product output unit is configured to receive a sale item dropped from the product channel and facilitate the sale item to slide towards a product output opening above the bottom plate.

2. The bracket supporting apparatus of claim 1, wherein the first side plate, the second side plate, the top plate, the bottom plate and the back plate corporately form an accommodating space; the first side plate is substantially parallel to the second side plate; the top plate is substantially parallel to the bottom plate; and each of the top plate, the bottom plate and the back plate is connected to each of the first side plate and the second side plate.

3. The bracket supporting apparatus of claim 1, wherein the plurality of first supporting brackets are arranged parallel to each other on the first side plate and the second side plate.

4. The bracket supporting apparatus of claim 1, wherein a plurality of limiting slots are formed in the first mounting bracket; the product output unit comprises a diagonal supporting plate; each of two shielding plates extend from each side of the supporting plate; a plurality of connecting brackets extend from the supporting plate; a limiting bracket perpendicularly extends from each of the plurality of connecting brackets; each of the plurality of limiting brackets passes through each of the plurality of limiting slots; and the product output unit is fixed to the back plate.

5. The bracket supporting apparatus of claim 4, wherein a length of each of the plurality of limiting brackets is substantially equal to a length of each of the plurality of limiting slots.

6. The bracket supporting apparatus of claim 4, wherein a plurality of fixing holes are formed in the second mounting bracket; a fixing bracket extends downwards from the supporting plate; a plurality of through holes are formed in the fixing bracket; a fastener passes through each of the plurality of through holes and each of the plurality of fixing holes; and the front of the product output unit is fixed to the second mounting bracket.

7. The bracket supporting apparatus of claim 6, wherein a diameter of each of the plurality of through holes is substantially equal to a diameter of each of the plurality of fixing holes.

8. The bracket supporting apparatus of claim 7, wherein each of the plurality of first supporting brackets is riveted to the first side plate and to the second side plate; each of the plurality of second supporting brackets is riveted to the top plate; and a distal end of each of the plurality of first supporting brackets is riveted to a distal end of each of the plurality of second supporting brackets.

9. A bracket supporting apparatus, comprising:
a cabinet body comprising a first side plate, a second side plate, a top plate, a bottom plate and a back plate;
a plurality of first supporting brackets mounted on the first side plate and on the second side plate and arranged longitudinally;
a plurality of second supporting brackets mounted on the top plate and arranged parallel to each other;
a product channel mounted on the top plate;
a first mounting bracket mounted on the back plate;
a second mounting bracket fixed to the first side plate and to the second side plate; and
a product output unit located in the cabinet body below the product channel; wherein the product output unit comprises a diagonal supporting plate; the product output unit is fixed to the first mounting bracket and to the second mounting bracket; and the supporting plate is configured to receive a sale item dropped from the product channel and facilitate the sale item to slide towards a product output opening above the bottom plate.

10. The bracket supporting apparatus of claim 9, wherein the first side plate, the second side plate, the top plate, the bottom plate and the back plate corporately form an accommodating space; the first side plate is substantially parallel to the second side plate; the top plate is substantially parallel to the bottom plate; and each of the top plate, the bottom plate and the back plate is connected to each of the first side plate and the second side plate.

11. The bracket supporting apparatus of claim 9, wherein the plurality of first supporting brackets are arranged parallel to each other on the first side plate and the second side plate.

12. The bracket supporting apparatus of claim 9, wherein a plurality of limiting slots are formed in the first mounting bracket; each of two shielding plates extends from each side of the supporting plate; a plurality of connecting brackets extend from the supporting plate; a limiting bracket perpendicularly extends from each of the plurality of connecting brackets; each of the plurality of limiting brackets passes through the limiting slots; and the product output unit is fixed to the back plate.

13. The bracket supporting apparatus of claim 12, wherein a length of each of the plurality of limiting brackets is substantially equal to a length of each of the plurality of limiting slots.

14. The bracket supporting apparatus of claim 12, wherein a plurality of fixing holes are formed in the second mounting bracket; a fixing bracket extends downwards from the supporting plate; a plurality of through holes are formed in the fixing bracket; a fastener passes through each of the plurality of through holes and each of the plurality of fixing holes; and the front of the product output unit is fixed to the second mounting bracket.

15. The bracket supporting apparatus of claim 14, wherein a diameter of each of the plurality of through holes is substantially equal to a diameter of each of the plurality of fixing holes.

16. The bracket supporting apparatus of claim 15, wherein each of the plurality of first supporting brackets are riveted to the first side plate and to the second side plate; each of the plurality of second supporting brackets is riveted to the top plate; and each of the plurality of first supporting brackets is riveted to a distal end of each of the plurality of second supporting brackets.
